(19) United States
(12) Patent Application Publication
(10) Pub. No.: US 2019/0066146 A1
(43) Pub. Date: Feb. 28, 2019

(54) PREMIUM GIVING SYSTEM, RECORDING MEDIUM HAVING STORED PREMIUM GIVING PROGRAM, AND PREMIUM GIVING METHOD

(71) Applicant: FUJITSU LIMITED, Kawasaki-shi (JP)

(72) Inventors: Xin Wang, Ota (JP); Masahiro Usui, Yokohama (JP); Hiroko Yuki, Yokohama (JP)

(73) Assignee: FUJITSU LIMITED, Kawasaki-shi (JP)

(21) Appl. No.: 16/178,022

(22) Filed: Nov. 1, 2018

Related U.S. Application Data
(63) Continuation of application No. PCT/JP2016/064520, filed on May 16, 2016.

(51) Int. Cl. G06Q 30/02; G06Q 40/06; G06Q 20/32

(52) U.S. Cl. CPC G06Q 30/0236; G06Q 20/3221; G06Q 40/06; G06Q 30/0279

(57) ABSTRACT

A system includes a processor receives a first input including first information indicating a recipient of an amount for a first electronic currency and an issuance request issuing the first electronic currency, or a second input including designation adding an amount for a second electronic currency to possession amount, outputs, when receiving the first input, a first screen requesting input of second information for a condition about whether to permit a grant of a premium of the first electronic currency, based on whether the first information corresponds to a first user of the issuance request or a second user, and outputs, when receiving the second input, a second screen requesting input of third information for a condition about whether to permit a grant of a premium of the second electronic currency to a terminal of a third user designating an addition of the amount and different from a fourth user.

### CROSS-REFERENCE TO RELATED APPLICATION

This application is a continuation application of International Application PCT/JP2016/064520 filed on May 16, 2016 and designated the U.S., the entire contents of which are incorporated herein by reference.

### FIELD

The embodiments discussed herein are related to premium giving systems, recording mediums having stored therein a premium giving program, and premium giving methods.

### BACKGROUND

There are various kinds of cash voucher.

Japanese Laid-open Patent Publication No. 2012-221130 discloses the related technique.

### SUMMARY

According to an aspect of the embodiments, a premium giving system includes: a memory; and a processor coupled the memory and configured to: receive a first input including first information indicating a recipient of an amount which is specified for a first electronic currency and an issuance request to issue the first electronic currency, or a second input including designation to add an amount which is specified for a second electronic currency to possession amount information; output, when receiving the first input, a first screen which requests input of second information to determine a condition about whether to permit a grant of a first premium of the first electronic currency, based on whether the first information corresponds to a first user who makes the issuance request or a second user different from the first user; and output, when receiving the second input, a second screen which requests input of third information to determine a condition about whether to permit a grant of a second premium of the second electronic currency to a terminal which is used by a third user in a case where the third user who designates an addition of the amount is different from a fourth user who requests issuance of the second electronic currency.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a schematic configuration of a system according to embodiment 1;

FIG. 2 is a diagram illustrating an example of the data structure of benefit-money pool information;

FIG. 3 is a diagram illustrating an example of the data structure of benefit-money payment-history information;

FIG. 4 is a diagram illustrating an example of the data structure of issuable cash voucher information;

FIG. 5 is a diagram illustrating an example of the data structure of issued cash voucher history information;

FIG. 6 is a diagram illustrating an example of a main screen;

FIG. 7 is a diagram illustrating an example of an individual number input screen;

FIG. 8 is a diagram illustrating an example of the issued cash voucher history information that is recorded;

FIG. 9 is a diagram illustrating an example of the issued cash voucher history information that is stored;

FIGS. 10A and 10B are a flowchart illustrating the procedure of a premium giving process; and

FIG. 11 is a diagram illustrating a computer that executes a premium giving program.

### DESCRIPTION OF EMBODIMENTS

Examples of cash vouchers include merchandise vouchers issued by companies or other organizations and regional development promotion tickets issued by local governments or the like. For example, the cash vouchers include ones that are given premiums depending on whether those who use the cash vouchers meet conditions. For example, a cash voucher with child-raising benefit money will have an amount with the benefit money added when it is issued to an eligible person, who is raising his/her children, but one received by an ineligible person will have an amount without the benefit money, which is the same as the original amount of the cash voucher. In this case, the issuer of the cash voucher checks whether a person to whom the cash voucher is to be issued is eligible for the premium, and gives the premium according to the check result. For example, a local government checks personal information on a person to whom the cash voucher is to be issued, such as his/her individual number, against information on people eligible to receive the benefit money and gives him/her the benefit money by adding the corresponding amount to the original amount of the cash voucher according to the check result. The individual number is an official number determined for each person in Japan based on the social security and tax number system (what is called the My Number System).

For example, an electronic cash voucher may be given by a first user to a second user.

For example, personal information such as the individual number that is not for giving a premium is associated with various kinds of information on the individual. For this reason, to avoid leakage of personal information, it is preferable to avoid unnecessary input of such information.

For example, a screen prompting the user to input his/her personal information may be outputted at the time of judging whether to give the user a premium.

Hereinafter, based on the drawings, description is provided in detail for examples of premium giving systems, premium giving programs, and premium giving methods according to the embodiments. The examples do not limit this embodiment. The embodiments may be combined as long as the processing contents of those do not contradict each other.

For example, for a merchandise voucher with a premium, such as benefit money, that is only given to those who have specific attributes, for example, attributes such as the family structure and the age have to be checked at issuance of the merchandise voucher. For this reason, in usual cases, a person himself/herself presents his/her personal information, such as his/her individual number, at a sales window of a bank before purchasing a merchandise voucher with a premium, and a bank clerk checks the personal information to determine whether he/she is eligible to receive the premium.

Meanwhile, it is conceivable that when user A who is not eligible for the benefit money purchases a merchandise voucher to give it to user B who is eligible for the benefit money, user A presents the individual number of the eligible user B to a bank and receives the cash voucher with the benefit money given, from the bank. However, since the individual number is information the leakage of which has to be avoided, it is undesirable to tell the individual number to others, and thus such operation is not acceptable in practical use. In the following, description is provided, as an example, for a case where unnecessary input of personal information, such as the individual number, is reduced to lower the possibility of leakage of such information, at the issuance of merchandise vouchers with benefit money as above as electronic currency.

### Embodiment 1

[System Configuration]

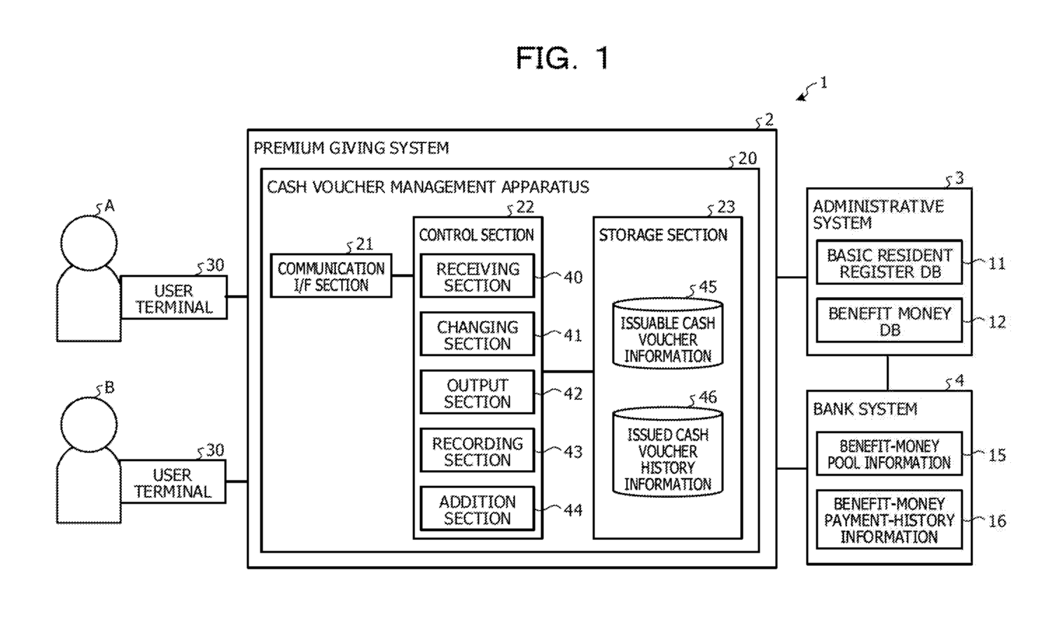

First, an example of a system 1 according to embodiment 1 is described. FIG. 1 is a diagram illustrating an example of a schematic configuration of the system according to embodiment 1. The system 1 provides the users with service related to cash vouchers, such as sales, transfer, and management of cash vouchers, giving premiums, transmitting and receiving messages, and the like. In this embodiment, description is provided for the case of giving benefit money to eligible people as a premium, as an example. The cash vouchers in this embodiment are associated with electronic information. The cash voucher may be, for example, data identified by a code expressed by a character string. The cash voucher may be, for example, a piece of paper on which a quick response (QR) code (registered trade mark) for determining information on the cash voucher is printed.

As illustrated in FIG. 1, the system 1 has a premium giving system 2 and user terminals 30. The user terminals 30 and premium giving system 2 of the system 1 are communicably connected to each other with a network. As a form of the network, any kind of communication network may be used, such as a local area network (LAN) or a virtual private network (VPN) whether it is wired or wireless. Although the example of FIG. 1 illustrates the case where there are two users, user A and user B, and two user terminals 30, the embodiment is not limited to this case, but there may be any number of users and user terminals 30.

The premium giving system 2 is a computer or a computer system that provides the users with service related to cash vouchers. The premium giving system 2 may be implemented in one computer or may also be implemented in multiple computers. In this embodiment, description is provided, as an example, for a case where the premium giving system 2 is implemented in one computer, in other words, as a cash voucher management apparatus 20. The premium giving system 2 is communicably connected to an administrative system 3 and a bank system 4 via a network. The administrative system 3 and the bank system 4 are also communicably connected to each other with a network.

The user terminals 30 are apparatuses owned by users who receive service from the premium giving system 2. For example, the user terminals 30 are mobile terminal apparatuses, such as smartphones or tablet PC terminals. The user terminals 30 may also be laptop computers or personal computers.

The administrative system 3 manages information on residents. For example, the administrative system 3 is disposed at each local public entity, such as each municipality, and manages various kinds of information on the residents, such as the names, individual numbers, birth dates, family structures of the residents, using a basic resident register database (DB) 11. The administrative system 3 also manages various kinds of information on benefit money, such as conditions for benefit money and the amount of benefit money to be provided, using a benefit money DB 12. The administrative system 3 is capable of checking whether a resident is eligible for benefit money by referring to the basic resident register DB 11 and the benefit money DB 12, and determining the amount of the benefit money if the resident is eligible.

The bank system 4 manages funds used for the administrative benefit money. For example, the bank system 4, which stores benefit-money pool information 15 and benefit-money payment-history information 16, pays benefit money according to instructions from the administrative system 3.

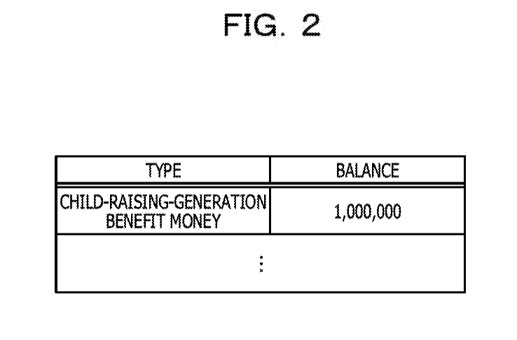

The benefit-money pool information 15 is data for storing information on benefit money. For example, in the benefit-money pool information 15, the balance of the fund for each kind of benefit money, or the like is stored. FIG. 2 is a diagram illustrating an example of the data structure of the benefit-money pool information. As illustrated in FIG. 2, the benefit-money pool information 15 has items such as “TYPE” and “BALANCE”. The items of the benefit-money pool information 15 illustrated in FIG. 2 are examples, and thus the benefit-money pool information 15 may have other items.

The item of “TYPE” is an area for storing the type of benefit money. For each type of benefit money, conditions for being eligible, the amount of the benefit money to be paid, and the total amount of the benefit money are determined. In the item of “TYPE”, information indicating the type of benefit money is stored. The item of “BALANCE” is an area for storing the balance of the benefit money. For example, in the example of FIG. 2, the balance of child-raising-generation benefit money is 1,000,000 Japanese yen.

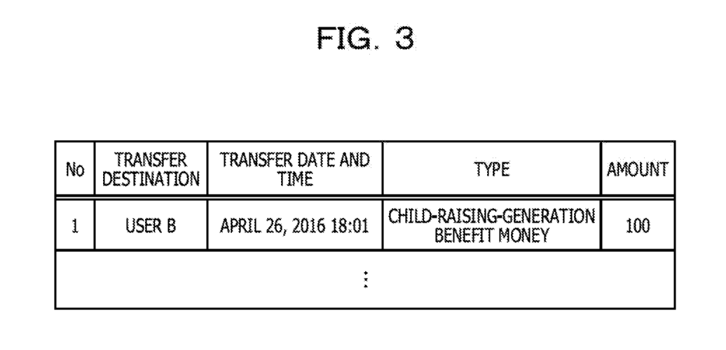

The benefit-money payment-history information 16 is data for storing information on the history of paying benefit money. For example, in the benefit-money payment-history information 16, a beneficiary to whom the benefit money was paid and the amount of the paid benefit money are stored. FIG. 3 is a diagram illustrating an example of the data structure of the benefit-money payment-history information. As illustrated in FIG. 3, the benefit-money payment-history information 16 has items such as “No.”, “TRANSFER DESTINATION”, “TRANSFER DATE AND TIME”, “TYPE”, and “AMOUNT”. The times of the benefit-money payment-history information 16 illustrated in FIG. 3 are examples, and thus the benefit-money payment-history information 16 may have other items.

The item of “No.” is an area for storing the number for identifying a payment history of benefit money. Each history of paying benefit money has a sequential number. The item of “TRANSFER DESTINATION” is an area for storing the beneficiary to whom the benefit money was paid. The items of “TRANSFER DATE AND TIME” is an area for storing the date and time when the benefit money was paid. The item of “TYPE” is an area for storing the type of the paid benefit money. The item of “AMOUNT” is an area storing the paid amount. For example, in the example of FIG. 3, the history No. “1” indicates that 100 yen of child-raising-generation benefit money was paid to user B at 18:01 on Apr. 26, 2016.

The cash voucher management apparatus 20 provides service related to cash vouchers. The cash voucher management apparatus 20 has a communication interface (I/F) section 21, a control section 22, and a storage section 23. The communication I/F section 21 controls communication between the cash voucher management apparatus 20 and other apparatuses. The communication I/F section 21 transmits and receives various kinds of information to and from the other apparatuses via a network. For the communication I/F section 21, a network interface card, such as a LAN card, may be used. The control section 22 has a receiving section 40, a changing section 41, an output section 42, a recording section 43, and an addition section 44.

The storage section 23 is a storage apparatus, such as a hard disk, a solid state drive (SSD), or an optical disk. The storage section 23 may be data rewritable semiconductor memory, such as random access memory (RAM), flash memory, or non-volatile static random access memory (NVSRAM). The storage section 23 may be a server apparatus, which stores and provides data.

The storage section 23 stores various programs. The storage section 23 stores various kinds of data used in the various programs. For example, the storage section 23 stores issuable cash voucher information 45 and issued cash voucher history information 46.

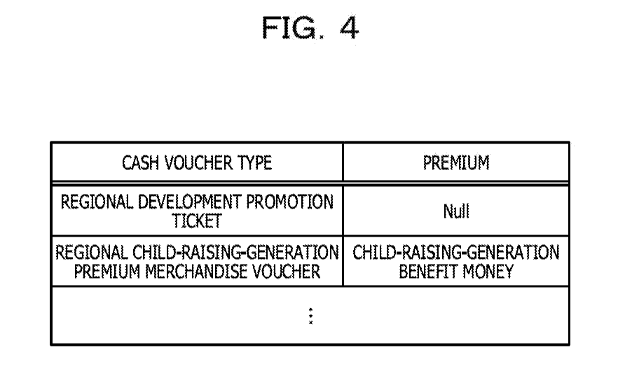

The issuable cash voucher information 45 is data in which information on cash vouchers issuable by the premium giving system 2 is stored. For example, in the issuable cash voucher information 45, the type of issuable cash voucher, the premium to be given, and the like are stored. FIG. 4 is a diagram illustrating an example of the data structure of the issuable cash voucher information. As illustrated in FIG. 4, the issuable cash voucher information 45 has items such as “CASH VOUCHER TYPE” and “PREMIUM”. The items of the issued cash voucher history information 46 illustrated in FIG. 4 are examples, and thus the issued cash voucher history information 46 may have other items.

The item of “CASH VOUCHER TYPE” is an area for storing information indicating the type of the issuable cash voucher. The item of “PREMIUM” is an area for storing information on a premium given to the cash voucher. In the item of “PREMIUM”, if there is a premium given to the cash voucher, information indicating the given premium is stored, and if there is no premium given to the cash voucher, “Null” is stored. For example, in the example of FIG. 4, the regional development promotion ticket has no premium to be given. For the regional child-raising-generation premium merchandise voucher, child-raising-generation benefit money is given as a premium.

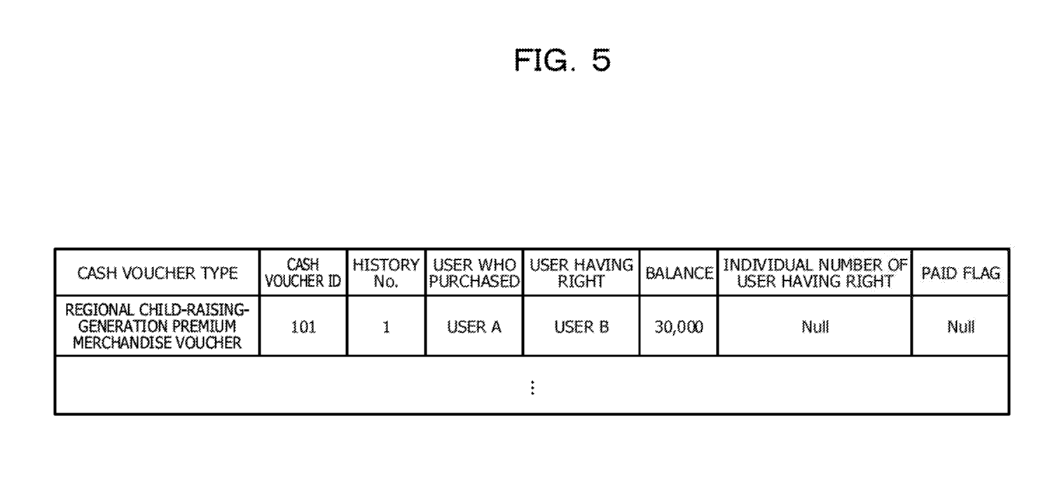

The issued cash voucher history information 46 is data in which history information on issued cash vouchers is stored. For example, in the issued cash voucher history information 46, the user who purchased the cash voucher, the balance of the cash voucher, and the like is stored for each issued cash voucher. FIG. 5 is a diagram illustrating an example of the data structure of the issued cash voucher history information. As illustrated in FIG. 5, the issued cash voucher history information 46 has items such as “CASH VOUCHER TYPE”, “CASH VOUCHER ID”, “HISTORY No.”, “USER WHO PURCHASED”, “USER HAVING RIGHT”, “BALANCE”, “INDIVIDUAL NUMBER OF USER HAVING RIGHT”, and “PAID FLAG”. The items of the issued cash voucher history information 46 illustrated in FIG. 5 are examples, and thus the issued cash voucher history information 46 has other items.

The item of “CASH VOUCHER TYPE” is an area for storing information on the type of the issued cash voucher. The item of “CASH VOUCHER ID” is an area for storing the ID to identify the issued cash voucher. In the item of “CASH VOUCHER ID”, the cash voucher ID of each cash voucher set at the purchase of the cash voucher is stored. The item of “history No.” is an area for storing a serial number of the transaction history on the cash voucher. The item of “USER WHO PURCHASED” is an area for storing the user who purchased the cash voucher. The item of “USER HAVING RIGHT” is an area for storing the user who has the right to use the cash voucher. The item of “BALANCE” is an area for storing the balance of the cash voucher. The item of “INDIVIDUAL NUMBER OF USER HAVING RIGHT” is an area for storing the individual number of the user having the right to use the cash voucher. In the item of “INDIVIDUAL NUMBER OF USER HAVING RIGHT”, if the individual number is specified, information on the specified individual number is stored, and if the individual number is not specified, “Null” is stored. The item of “PAID FLAG” is an area for storing whether benefit money has already been paid for the cash voucher. In the item of “PAID FLAG”, if benefit money has already been paid, information indicating that benefit money has already been paid is stored, and if benefit money has not been paid, “Null” is stored.

The receiving section 40 receives various operations. For example, when receiving an access from the user terminal 30, the receiving section 40 transmits information on various operation screens to the access origin to make the user terminal 30, which is the access origin, display the operation screens and receives various operations through the operation screens. For example, the receiving section 40 provides a website for service on cash vouchers. When receiving an access to the website for service on cash vouchers from the user terminal 30, the receiving section 40 transmits information on a login screen to the user terminal 30, which is the access origin, to make the user terminal 30 display the login screen, and receives a login operation with an inputted login ID and password. When receiving the login operation, the receiving section 40 compares the inputted login ID and password with the login ID and password registered in advance to perform authentication. When the inputted login ID and password are authenticated, the receiving section 40 transmit information on a main screen for service on cash vouchers to the user terminal 30, which is the access origin, to make the user terminal 30 display the main screen.

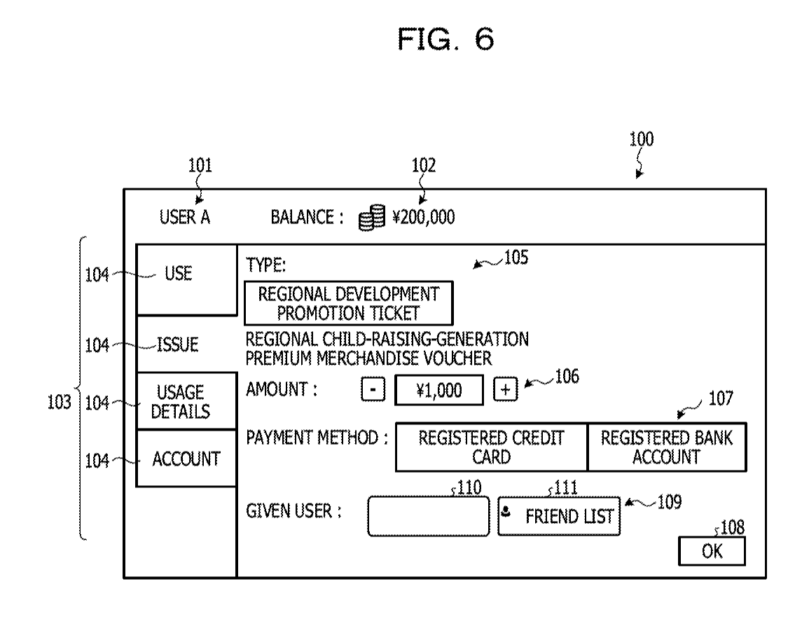

FIG. 6 is a diagram illustrating an example of the main screen. The example of FIG. 6 is an example of a main screen displayed on the user terminal 30. The main screen 100 has a user name display area 101 for displaying a user name, a balance display area 102 for displaying the balance of a cash voucher issued as electronic currency of the user, and a main area 103. The main area 103 has tabs 104 for “USE”, “ISSUE”, “USAGE DETAILS”, and “ACCOUNT”, and the display contents of the main area 103 is switchable by these tabs 104. The “USE” tab 104 is used to display an operation screen for using a cash voucher issued an electronic currency in the main area 103. The “ISSUE” tab 104 is used to display an operation screen for issuing a cash voucher as electronic currency in the main area 103. The “USAGE DETAILS” tab 104 is used to display an operation screen for the user to check usage details of a cash voucher in the main area 103. The “ACCOUNT” tab 104 is used to display an operation screen for various registrations, such as registration of a user who is the user's friend, in the main area 103. In the example of FIG. 6, the “ISSUE” tab 104 is now selected.

The main area 103 has a cash voucher selection area 105 for selecting a cash voucher to be issued, an amount selection area 106 for selecting the amount of the cash voucher to be issued, a payment selection area 107 for selecting the method to pay the amount, and an OK button 108 for instructing the issuance of the cash voucher.

The service on cash vouchers according to this embodiment allows the user to give a cash voucher issued as electronic currency to a different user. The main area 103 has a designation area 109 for designating a given user when the user gives a cash voucher to a different user. The designation area 109 has an input area 110 for directly inputting the given user and a friend list button 111. When a cash voucher is given to a different user, information on the given user is inputted in the input area 110. The information on the user may be any information as long as the information identifies a user, for example, the login ID or the email address of the user. When the user selects the friend list button 111, a list screen displaying a list of other users registered as friends of the logged-in user appears, and the list screen allows the user to select a given user. When the user select a given user from a list screen, the input area 110 displays information on the given user, such as the login ID or the email address of the selected given user.

The receiving section 40 receives a request for issuing electronic currency with information indicating the recipient of the amount specified for the electronic currency, designated on the main screen 100. For example, when the user to be given the cash voucher is designated by the inputted information on the user in the main area 103, the receiving section 40 receives the request for issuing electronic currency with the designated user as the recipient. When the main area 103 is left blank, in other words, the recipient of the cash voucher is not designated by the user, the receiving section 40 receives the request for issuing electronic currency, understanding that the recipient of the cash voucher is the logged-in user himself/herself. The main area 103 may have a button for designating the logged-in user himself/herself as the recipient of the cash voucher.

The recording section 43 records the transaction histories of cash vouchers in the issued cash voucher history information 46. For example, when the receiving section 40 receives the issuance of a cash voucher, the recording section 43 registers information on the issued cash voucher in the issued cash voucher history information 46. When receiving a transaction for giving an issued cash voucher, the recording section 43 registers the history of the received transaction on the cash voucher in the issued cash voucher history information 46.

The changing section 41 makes various changes. For example, when receiving a request for issuing a cash voucher as electronic currency by the OK button 108 being selected on the main screen 100, the changing section 41 determines whether the cash voucher the issuance request of which has been received is a cash voucher for which a premium is to be given, based on the issuable cash voucher information 45. For example, the regional child-raising-generation premium merchandise voucher is determined to be a cash voucher for which a premium is to be given. When the cash voucher the issuance request of which has been received is determined to be a cash voucher for which a premium is to be given, the changing section 41 changes whether to output a screen for requesting input of information on the condition for determining whether to permit giving the premium on the electronic currency, depending on the user designated as the recipient. For example, when the information indicating the designated recipient corresponds to the user who requested issuance of the cash voucher, the changing section 41 permits displaying a screen requesting the user to input his/her individual number, to determines whether the logged-in user is eligible for the benefit money. On other hand, when the information indicating the designated recipient corresponds to another user different from the user who requested issuance of the cash voucher, the changing section 41 prohibits displaying the screen requesting the user to input his/her individual number.

The output section 42 outputs information on an individual number input screen requesting input of the individual number, depending on the change result by the changing section 41 about whether to output the screen. For example, if the information indicating the recipient corresponds to the logged-in user, and displaying the screen is permitted, the output section 42 transmits, for example, information on the individual number input screen as information on an input screen to judge whether the user is eligible for the premium, to the user terminal 30 used by the logged-in user, and makes the user terminal 30 display the individual number input screen. On the other hand, if the information indicating the recipient corresponds to another user different from the logged-in user, and displaying the screen is prohibited, the output section 42 does not perform the process of displaying the individual number input screen. The output section 42 may output a notification to the different user that a cash voucher has been given to the different user as electronic currency. For example, the output section 42 transmits, to the email address of the different user, an email including a message that a cash voucher has been given to the different user and the link to the website for service on the cash voucher. The different user receives the email with the user terminal 30 and accesses to the website for service on the cash voucher using the link. When the website is accessed by the different user, the output section 42 transmits information on the individual number input screen to the user terminal 30 used by the different user who has accessed, and makes the user terminal 30 display the individual number input screen.

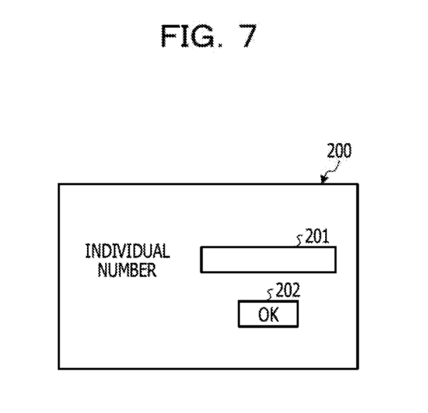

FIG. 7 is a diagram illustrating an example of the individual number input screen. The example of FIG. 7 illustrates an example of the individual number input screen displayed on the user terminal 30. The individual number input screen 200 has an input area 201 for inputting the individual number and an OK button 202.

The receiving section 40 receives input of the individual number on the individual number input screen 200 as information on the condition for determining whether to give a premium on the electronic currency.

When receiving the input of the individual number on the individual number input screen 200, the addition section 44 notifies the administrative system 3 of the inputted individual number.

The administrative system 3 refers to the basic resident register DB 11 and the benefit money DB 12 to check whether the user corresponding to the individual number is eligible for the benefit money. The administrative system 3 notifies the cash voucher management apparatus 20 of the check result. If the user corresponding to the individual number is eligible for the benefit money, the administrative system 3 also instructs the bank system 4 to pay the benefit money, specifying the amount to be paid.

When the bank system 4 is instructed from the administrative system 3 to pay the benefit money, the bank system 4 notifies the cash voucher management apparatus 20 of the payment of the benefit money along with the amount to be paid. The bank system 4 performs provision transaction of the amount to be paid on the benefit money DB 12 and stores information such as the beneficiary to which the benefit money was paid and the paid amount in the benefit-money payment-history information 16.

When notified by the bank system 4 of the payment of the benefit money, the addition section 44 adds the paid amount, together with the amount of the electronic currency, to the possession amount stored in association with the user who was determined to be eligible for the benefit money. For example, the addition section 44 adds the paid amount of the benefit money to the balance of the cash voucher issued as electronic currency.

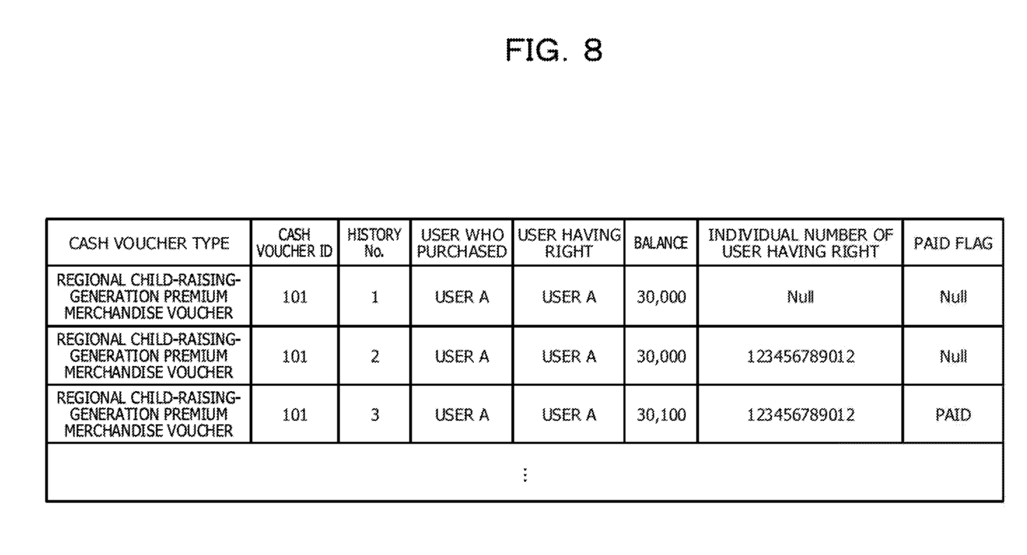

Here, the process flow of giving a premium is described using a specific example. First, description is provided for the process flow of giving a premium to a user who requests issuance of a cash voucher. In the following, assume that a user who requests issuance of a cash voucher is user A, and a user who is given the cash voucher is user B. FIG. 8 is a diagram illustrating an example of the issued cash voucher history information that is recorded.

User A accesses the website for service on cash vouchers using the user terminal 30 and inputs his/her login ID and password to log in the service on cash vouchers. Then, the user terminal 30 displays the main screen 100 illustrated in FIG. 6. On the main screen 100, user A requests issuance of a regional child-raising-generation premium merchandise voucher for 30,000 yen to user A himself/herself. For example, user A selects the “ISSUE” tab 104 on the main screen 100 and then selects the regional child-raising-generation premium merchandise voucher in the cash voucher selection area 105. User A inputs 30,000 yen in the amount selection area 106, selects a payment method in the payment selection area 107, and leaves the input area 110 blank, then selects the OK button 108.

When the receiving section 40 receives the issuance of the cash voucher, the recording section 43 registers information on the issued cash voucher in the issued cash voucher history information 46. For example, as illustrated in the record indicated by history No. “1” in FIG. 8, the recording section 43 issues a cash voucher ID “101” and registers “REGIONAL CHILD-RAISING-GENERATION PREMIUM MERCHANDISE VOUCHER” in CASH VOUCHER TYPE, “USER A” in USER WHO PURCHASED and USER HAVING RIGHT, “Null” in INDIVIDUAL NUMBER OF USER HAVING RIGHT and PAID FLAG, and “30,000” in BALANCE.

When receiving the request for issuing the cash voucher as electronic currency, the changing section 41 determines whether the regional child-raising-generation premium merchandise voucher is a cash voucher for which a premium is to be given, based on the issuable cash voucher information 45. The changing section 41 determines that the regional child-raising-generation premium merchandise voucher is a cash voucher for which a premium is to be given. When determining that the regional child-raising-generation premium merchandise voucher is a cash voucher for which a premium is to be given, the changing section 41 determines whether the user designated as the recipient is the same as the user who requested issuance of the cash voucher. Since the input area 110 is blank, the changing section 41 determines that the user designated as the recipient is the same as the user who requested issuance of the cash voucher. The changing section 41 permits displaying a screen requesting input of the individual number.

When displaying the screen is permitted, the output section 42 transmits information on the individual number input screen 200 to the user terminal 30 used by the logged-in user A and makes the user terminal 30 display the individual number input screen 200.

User A inputs his/her individual number in the input area 201 on the individual number input screen 200 and then selects the OK button 202. The receiving section 40 receives the input of the individual number on the individual number input screen 200.

When the user of the recipient is the same as the user who requested issuance of the cash voucher and the receiving section 40 receives the input of the individual number, the recording section 43 registers information on the issued cash voucher in the issued cash voucher history information 46. For example, as illustrated in the record indicated by history No. “2” in FIG. 8, the recording section 43 registers the individual number inputted in the item of INDIVIDUAL NUMBER OF USER HAVING RIGHT, on the cash voucher ID “101”.

The addition section 44 notifies the administrative system 3 of the inputted individual number.

If the user corresponding to the individual number in the notification to the administrative system 3 is eligible for a benefit money, the bank system 4 sends notification of payment of the benefit money along with the amount to be paid. For example, if user A is eligible for the child raising benefit money, the bank system 4 sends notification of the payment of the benefit money along with the amount to be paid. Here, assume that the notification indicates that the benefit money is 100 yen.

When the cash voucher management apparatus 20 is notified by the bank system 4 of the payment of the benefit money, the addition section 44 adds the paid amount of the benefit money, together with the amount of the electronic currency, to the possession amount stored in association with the user who was determined to be eligible for the benefit money. For example, as illustrated in the recode indicated by history No. “3” in FIG. 8, the recording section 43 adds the paid amount 100 yen to the balance so that the balance is “30,100” and registers “PAID” in PAID FLAG on the cash voucher ID “101”.

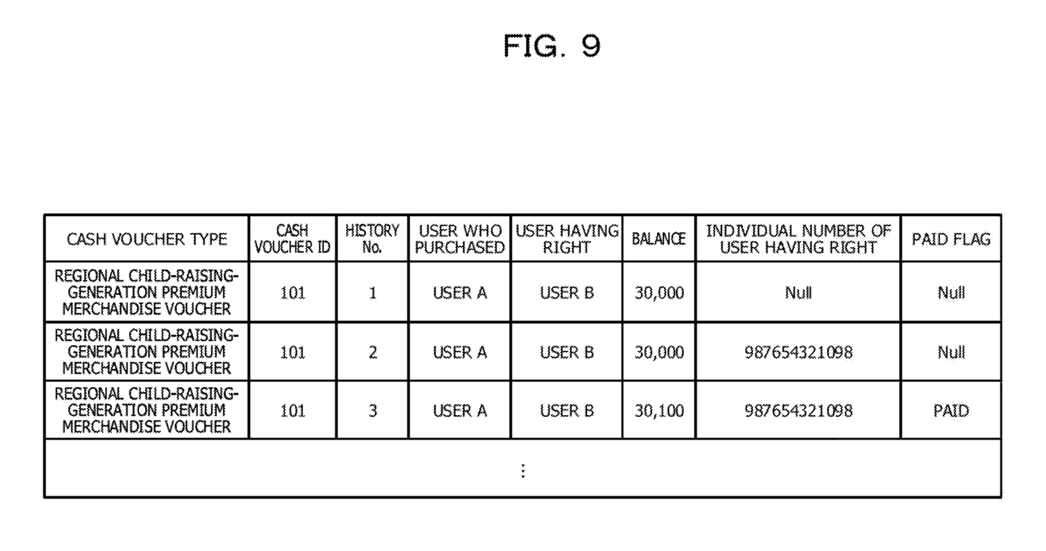

Next, description is provided for the process flow of giving a premium to the user who is given a cash voucher. Also in the following, assume that a user who requests issuance of a cash voucher is user A, and a user who is given the cash voucher is user B. FIG. 9 is a diagram illustrating an example of the issued cash voucher history information that is recorded.

User A accesses the website for service on cash vouchers using the user terminal 30 and inputs his/her login ID and password to log in the service on cash vouchers. Then, the user terminal 30 displays the main screen 100 illustrated in FIG. 6. On the main screen 100, user A requests issuance of a regional child-raising-generation premium merchandise voucher for 30,000 yen, designating user B to whom user A will give the regional child-raising-generation premium merchandise voucher. For example, user A selects the “ISSUE” tab 104 on the main screen 100 and then selects the regional child-raising-generation premium merchandise voucher in the cash voucher selection area 105. User A inputs 30,000 yen in the amount selection area 106, selects a payment method in the payment selection area 107, and inputs information identifying user B, such as the login ID or email address of user B, in the input area 110, then selects the OK button 108.

When the receiving section 40 receives the issuance of the cash voucher, the recording section 43 registers information on the issued cash voucher in the issued cash voucher history information 46. For example, as illustrated in the record indicated by history No. “1” in FIG. 9, the recording section 43 issues a cash voucher ID “101” and registers “REGIONAL CHILD-RAISING-GENERATION PREMIUM MERCHANDISE VOUCHER” in CASH VOUCHER TYPE, “USER A” in USER WHO PURCHASED, “USER B” in USER HAVING RIGHT, “Null” in INDIVIDUAL NUMBER OF USER HAVING RIGHT and PAID FLAG, and “30,000” in BALANCE.

When receiving the request for issuing the cash voucher as electronic currency, the changing section 41 determines whether the regional child-raising-generation premium merchandise voucher is a cash voucher for which a premium is to be given, based on the issuable cash voucher information 45. The changing section 41 determines that the regional child-raising-generation premium merchandise voucher is a cash voucher for which a premium is to be given. When determining that the regional child-raising-generation premium merchandise voucher is a cash voucher for which a premium is to be given, the changing section 41 determines whether the user designated as the recipient is the same as the user who requested issuance of the cash voucher. Since the information on user B has been inputted in the input area 110, the changing section 41 determines that the user designated as the recipient is different from the user who requested issuance of the cash voucher. The changing section 41 prohibits displaying the screen requesting input of the individual number. As a result, the individual number input screen 200 is not outputted to user A.

The output section 42 transmits, to the email address of user B, an email including a message that a cash voucher has been given to user B and the link to the website for service on the cash voucher.

User B receives the email with the user terminal 30 and accesses to the website for service on the cash voucher using the link.

When the website is accessed by user B, the output section 42 transmits information on the individual number input screen 200 to the user terminal 30 used by user B who has accessed, and makes the user terminal 30 display the individual number input screen 200.

User B inputs his/her individual number in the input area 201 on the individual number input screen 200 and then selects the OK button 202. The receiving section 40 receives the input of the individual number on the individual number input screen 200.

When the receiving section 40 receives the individual number of user B who is the recipient user different from user A who requested issuance of the cash voucher, the recording section 43 registers information on the issued cash voucher in the issued cash voucher history information 46. For example, as illustrated in the record indicated by history No. “2” in FIG. 9, the recording section 43 registers the individual number inputted in the item of INDIVIDUAL NUMBER OF USER HAVING RIGHT, on the cash voucher ID “101”.

The addition section 44 notifies the administrative system 3 of the inputted individual number.

If the user corresponding to the individual number in the notification to the administrative system 3 is eligible for a benefit money, the bank system 4 sends notification of payment of the benefit money along with the amount to be paid. For example, if user B is eligible for the child raising benefit money, the bank system 4 sends notification of the payment of the benefit money along with the amount to be paid. Here, assume that the notification indicates that the benefit money is 100 yen.

When the cash voucher management apparatus 20 is notified by the bank system 4 of the payment of the benefit money, the addition section 44 adds the paid amount of the benefit money, together with the amount of the electronic currency, to the possession amount stored in association with the user who was determined to be eligible for the benefit money. For example, as illustrated in the recode indicated by history No. “3” in FIG. 9, the recording section 43 adds the paid amount 100 yen to the balance so that the balance is “30,100” and registers “PAID” in PAID FLAG on the cash voucher ID “101”.

[Process Flow]

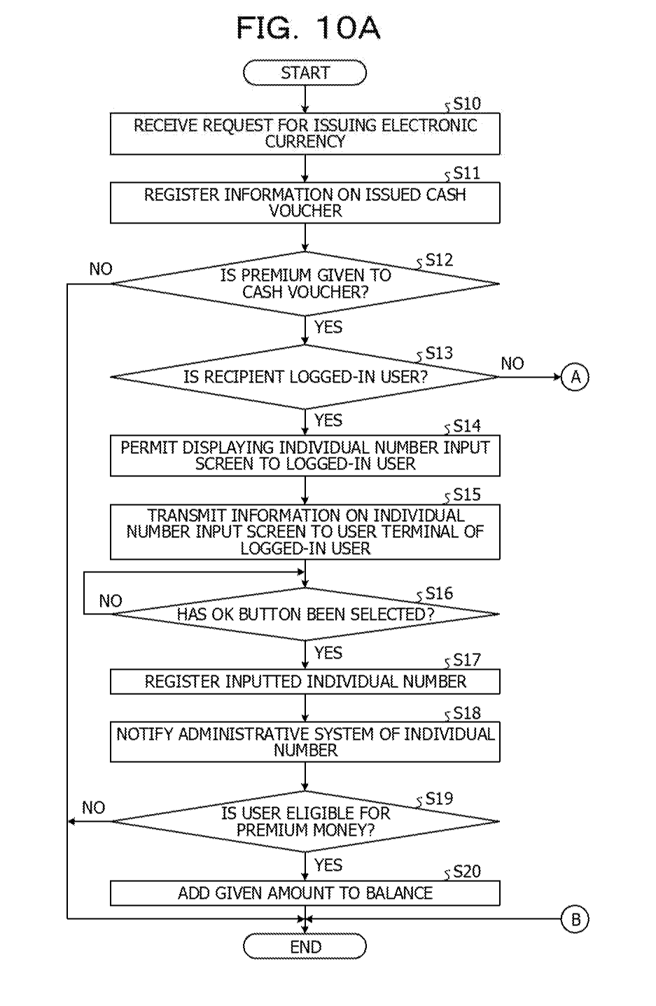

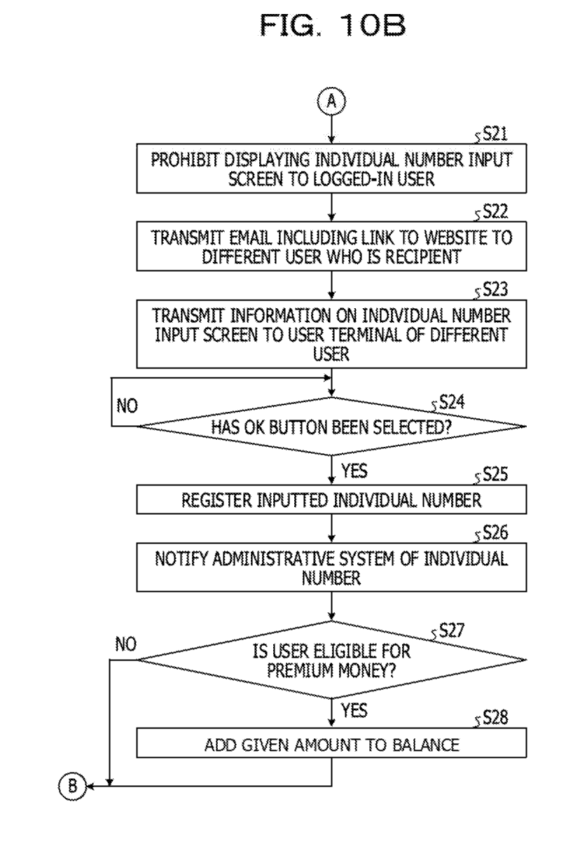

Next, description is provided for the premium giving process executed by the system 1 according to this embodiment. FIGS. 10A and 10B are a flowchart illustrating the procedure of the premium giving process. The premium giving process illustrated in FIGS. 10A and 10B is executed at a specified timing, for example, at the time when the OK button 108 is selected on the main screen 100.

When the OK button 108 is selected on the main screen 100, the receiving section 40 receives the request for issuing electronic currency with the information indicating the recipient of the amount specified for the electronic currency (S10).

When the receiving section 40 receives the request for issuing the cash voucher, the recording section 43 registers information on the issued cash voucher in the issued cash voucher history information 46 (S11).

The changing section 41 determines whether the cash voucher the issuance request of which has been received is a cash voucher for which a premium is to be given, based on the issuable cash voucher information 45 (S12). If the cash voucher the issuance request of which has been received is not a cash voucher for which a premium is to be given (No at S12), the process ends.

On the other hand, If the cash voucher the issuance request of which has been received is a cash voucher for which a premium is to be given (Yes at S12), the changing section 41 determines whether the user designated as the recipient is the logged-in user (S13). For example, if information on the user has been inputted in the main area 103, and the inputted information on the user is information on a user different from the logged-in user, the receiving section 40 determines that the recipient is different from the logged-in user. If information on the user has been inputted in the main area 103, and the inputted information on the user is the information on the logged-in user, the receiving section 40 determines that the recipient is the logged-in user. If the main area 103 is left blank, the receiving section 40 determines that the recipient is the logged-in user.

If the user of the recipient is the logged-in user (Yes at S13), the changing section 41 permits displaying the individual number input screen 200 to the logged-in user (514). The output section 42 transmits information on the individual number input screen 200 to the user terminal 30 used by the logged-in user, and makes the user terminal 30 display the individual number input screen 200 (S15).

The logged-in user inputs his/her individual number in the input area 201 on the individual number input screen 200 and then selects the OK button 202.

The receiving section 40 determines whether the OK button 202 on the individual number input screen 200 has been selected (S16). If the OK button 202 has not been selected (No at S16), the process moves to S16 again and waits for the selection of the OK button 202. If the OK button 202 has been selected (Yes at S16), the recording section 43 registers the inputted individual number in the issued cash voucher history information 46 on the issued cash voucher (S17).

The addition section 44 notifies the administrative system 3 of the inputted individual number (S18).

The administrative system 3 refers to the basic resident register DB 11 and the benefit money DB 12 to check whether the user corresponding to the individual number is eligible for the benefit money. The administrative system 3 notifies the cash voucher management apparatus 20 of the check result. If the user corresponding to the individual number is eligible for the benefit money, the administrative system 3 also instructs the bank system 4 to pay the benefit money, specifying the amount to be paid. When the bank system 4 is instructed from the administrative system 3 to pay the benefit money, the bank system 4 notifies the cash voucher management apparatus 20 of the payment of the benefit money along with the amount to be paid.

The addition section 44 determines whether the cash voucher management apparatus 20 has received the notification that the user is eligible for the benefit money (S19). If the cash voucher management apparatus 20 has not received the notification that the user is eligible for the benefit money (No at S19), the process ends.

On the other hand, If the cash voucher management apparatus 20 has received the notification that the user is eligible for the benefit money (Yes at S19), the recording section 43, on the issued cash voucher, adds the amount instructed from the bank system 4 to the balance and registers “PAID” in the paid flag of the issued cash voucher history information 46 (S20), and the process ends.

On the other hand, if the user of the recipient is different from the logged-in user (No at S13), the changing section 41 prohibits displaying the individual number input screen 200 to the logged-in user (S21). The output section 42 transmits, to the email address of the different user, an email including a message that a cash voucher has been given to the different user and the link to the website for service on the cash voucher (S22). When the different user accesses the website for service on the cash voucher with the user terminal 30 using the link attached to the email, the output section 42 transmits information on the individual number input screen 200 to the user terminal 30 used by the different user who has accessed and makes the user terminal 30 display the individual number input screen 200 (S23).

The different user designated as the recipient inputs his/her individual number in the input area 201 on the individual number input screen 200 and then selects the OK button 202.

The receiving section 40 determines whether the OK button 202 on the individual number input screen 200 has been selected (S24). If the OK button 202 has not been selected (No at S24), the process moves to S24 again and waits for the selection of the OK button 202. If the OK button 202 has been selected (Yes at S24), the recording section 43 registers the inputted individual number in the issued cash voucher history information 46 on the issued cash voucher (S25).

The addition section 44 notifies the administrative system 3 of the inputted individual number (S26).

The administrative system 3 refers to the basic resident register DB 11 and the benefit money DB 12 to check whether the user corresponding to the individual number is eligible for the benefit money. The administrative system 3 notifies the cash voucher management apparatus 20 of the check result. If the user corresponding to the individual number is eligible for the benefit money, the administrative system 3 also instructs the bank system 4 to pay the benefit money, specifying the amount to be paid. When the bank system 4 is instructed from the administrative system 3 to pay the benefit money, the bank system 4 notifies the cash voucher management apparatus 20 of the payment of the benefit money along with the amount to be paid.

The addition section 44 determines whether the cash voucher management apparatus 20 has received the notification that the user is eligible for the benefit money (S27). If the cash voucher management apparatus 20 has not received the notification that the user is eligible for the benefit money (No at S27), the process ends.

On the other hand, If the cash voucher management apparatus 20 has received the notification that the user is eligible for the benefit money (Yes at S27), the recording section 43, on the issued cash voucher, adds the amount instructed from the bank system 4 to the balance and registers “PAID” in the paid flag of the issued cash voucher history information 46 (S28), and the process ends.

### Advantageous Effect

The premium giving system 2 according to this embodiment receives the information indicating the recipient of the amount specified for electronic currency and the request for issuing the electronic currency. The premium giving system 2 changes whether to output the individual number input screen 200 for requesting input of information on the condition for determining whether to permit giving the premium on the electronic currency is permitted, depending on which the received information indicating the recipient corresponds to, information on user A who requested the issuance or information or user B different from user A. This allows the premium giving system 2 to output a screen prompting user A to input his/her personal information, at the time of judging whether to give the premium.

When the information indicating the recipient corresponds to the information on user A, the premium giving system 2 outputs the individual number input screen 200. This allows the premium giving system 2 to output the individual number input screen 200, at the time of judging whether to give the premium to user A who was designated as the recipient.

The premium giving system 2 receives input of the individual number on the individual number input screen 200 as information on the condition to determine whether to give a premium on electronic currency. When judging that user A is eligible for the premium based on the received individual number, the premium giving system 2 adds the amount of the premium provided from the account for managing money used for giving the premium, together with the amount of the electronic currency, to the possession amount stored in association with user A. This allows the premium giving system 2 to add the amount of the premium for user A appropriately when it is judged that user A is eligible for the premium.

The premium giving system 2 receives designation for adding the amount specified for electronic currency to the possession amount information of user B. When user B who was designated such that the amount specified for the electronic currency is added to the possession amount information of user B is different from user A who requested issuance of the electronic currency, the premium giving system 2 outputs the individual number input screen 200 to the terminal used by the designated user B. This allows the premium giving system 2 to prompt user B to input his/her personal information at the time of judging whether to give the premium to user B.

The premium giving system 2 receives input of the individual number on the individual number input screen 200 as information on the condition to determine whether to give a premium on electronic currency. When judging that user B is eligible for the premium based on the received individual number, the premium giving system 2 adds the amount of the premium provided from the account for managing money used for giving the premium, together with the amount of the electronic currency, to the possession amount stored in association with user B. This allows the premium giving system 2 to add the amount of the premium for user B appropriately when it is judged that user B is eligible for the premium.

The cash voucher management apparatus 20 according to this embodiment does not necessarily have to have all sections of the receiving section 40, changing section 41, output section 42, recording section 43, and addition section 44 illustrated in FIG. 1, to provide the above effects. For example, these sections may be disposed separately across multiple servers.

### Embodiment 2

Although the embodiment of the disclosed apparatus has been described up to this point, the disclosed technique may be used in various different forms other than the embodiment described above. In the following, other embodiments included in this embodiment are described.

For example, in the above embodiment, the description has been provided, as an example, for the case of using the individual number as the information on the condition for determining whether to permit giving a premium on electronic currency. However, personal information other than the individual number may be used as long as it identifies each individual.

Although in the above embodiment, the description has been provided, as an example, for the case of using a merchandise voucher with benefit money as electronic currency, the embodiment may be applied to a case of giving a premium when companies or other organizations issue points as electronic currency.

Although in the above embodiment, the description has been provided, as an example, for the case where the recording section 43 records transaction histories on a cash voucher in the issued cash voucher history information 46, the recording section 43 may record only the latest history on the cash voucher. In other words, for example, the recording section 43 may record only the information corresponding to the history having the largest history No. for each cash voucher ID in the issued cash voucher history information 46.

The functions of the illustrated constituents of each apparatus are conceptual, which means these constituents are not necessarily physically configured as in the illustration. In other words, for example, the concrete structure of each apparatus in terms of separation and integration is not limited to the ones illustrated in the figures. All or part of the apparatus may be configured separately or integrally in terms of functions or physical partitions on an arbitrary basis depending on various loads and usage conditions. For example, the processing sections of the receiving section 40, changing section 41, output section 42, recording section 43, and addition section 44 of the cash voucher management apparatus 20 may be integrated or separated as appropriate. All or any part of the processing functions performed by the processing sections may be implemented by a CPU and a program analyzed and executed by the CPU, or may be implemented as hardware using wired logic circuits.

[Premium Giving Program]

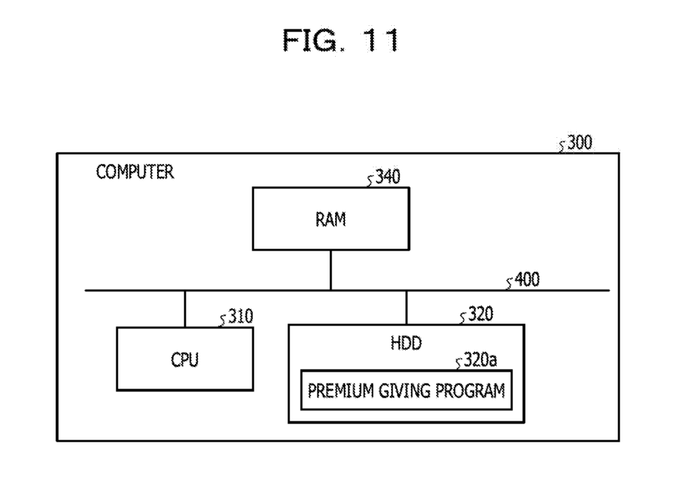

Various processes described in the above embodiment may be performed by executing a program, prepared in advance, on a computer system, such as a personal computer or a work station. Thus, in the following, description is provided for an example of a computer system that executes a program having the same function as the above embodiments. FIG. 11 is a diagram illustrating a computer that executes a premium giving program.

As illustrated in FIG. 11, a computer 300 has a CPU 310, a hard disk drive (HDD) 320, and a random access memory (RAM) 340. These units 310 to 340 are connected to one another via a bus 400.

The HDD 320 stores in advance a premium giving program 320a serving as the same functions as the processing sections in the above embodiments. For example, the stored premium giving program 320a serves as the same functions as the receiving section 40, changing section 41, output section 42, recording section 43, and addition section 44 in the above embodiments. Note that the premium giving program 320a may be separated as appropriate.

The HDD 320 also stores various kinds of data. For example, the HDD 320 stores the OS and various kinds of data.

The CPU 310 reads the premium giving program 320a from the HDD 320 and executes the premium giving program 320a to perform the same operations as the receiving section 40, changing section 41, output section 42, recording section 43, and addition section 44 in the embodiments. In other words, for example, the premium giving program 320a performs the same operations as the receiving section 40, changing section 41, output section 42, recording section 43, and addition section 44 of the cash voucher management apparatus 20 in the embodiments.

The above premium giving program 320a is not necessarily stored in the HDD 320 in the initial state. For example, the programs are stored in a “portable physical medium”, such as a flexible disk (FD), a compact disk read only memory (CD-ROM), and a digital versatile disk (DVD), a magneto-optical disk, and an IC card, which are inserted into the computer 300. The computer 300 may read programs from these mediums to execute the programs.

The programs may be stored in “another computer (or a server)” or the like connected to the computer 300 via a public line, the Internet, a LAN, a WAN, or the like. The computer 300 may read the programs from it to execute the programs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A premium giving system comprising:
a memory; and
a processor coupled the memory and configured to:
receive a first input including first information indicating a recipient of an amount which is specified for a first electronic currency and an issuance request to issue the first electronic currency, or a second input including designation to add an amount which is specified for a second electronic currency to possession amount information;
output, when receiving the first input, a first screen which requests input of second information to determine a condition about whether to permit a grant of a first premium of the first electronic currency, based on whether the first information corresponds to a first user who makes the issuance request or a second user different from the first user; and
output, when receiving the second input, a second screen which requests input of third information to determine a condition about whether to permit a grant of a second premium of the second electronic currency to a terminal which is used by a third user in a case where the third user who designates an addition of the amount is different from a fourth user who requests issuance of the second electronic currency.

2. The premium giving system according to claim 1, wherein the processor is configured to output the first screen when the first information corresponds to the first user.

3. The premium giving system according to claim 1, wherein
the processor is configured to:
receive the input of the second information on the first screen; and
add, when judging that the first user is eligible for the first premium based on the second information, a premium amount which is provided from an account which manages money for the grant of the first premium, together with the amount of the first electronic currency, to a possession amount which is stored in association with the first user.

4. The premium giving system according to claim 1, wherein
the processor is configured to:
receive the input of the third information on the second screen; and
add, when judging that the third user is eligible for the second premium based on the third information, a premium amount which is provided from an account which manages money used for the grant of the second premium, together with the amount of the second electronic currency, to a possession amount which is stored in association with the third user.

5. A non-transitory computer-readable medium recording a premium giving program which causes a computer to preform a process, the process comprising:
receiving a first input including first information indicating a recipient of an amount which is specified for a first electronic currency and an issuance request to issue the first electronic currency, or a second input including designation to add an amount which is specified for a second electronic currency to possession amount information;
outputting, when receiving the first input, a first screen which requests input of second information to determine a condition about whether to permit a grant of a first premium of the first electronic currency, based on whether the first information corresponds to a first user who makes the issuance request or a second user different from the first user; and
outputting, when receiving the second input, a second screen which requests input of third information to determine a condition about whether to permit a grant of a second premium of the second electronic currency to a terminal which is used by a third user in a case where the third user who designates an addition of the amount is different from a fourth user who requests issuance of the second electronic currency.

6. The non-transitory computer-readable medium according to claim 5, wherein the first screen is output when the first information corresponds to the first user.

7. The non-transitory computer-readable medium according to claim 5, further comprising:
receiving the input of the second information on the first screen; and
adding, when judging that the first user is eligible for the first premium based on the second information, a premium amount which is provided from an account which manages money for the grant of the first premium, together with the amount of the first electronic currency, to a possession amount which is stored in association with the first user.

8. The non-transitory computer-readable medium according to claim 5, further comprising:
receiving the input of the third information on the second screen; and
adding, when judging that the third user is eligible for the second premium based on the third information, a premium amount which is provided from an account which manages money used for the grant of the second premium, together with the amount of the second electronic currency, to a possession amount which is stored in association with the third user.

9. A premium giving method comprising:
receiving, by a computer, a first input including first information indicating a recipient of an amount which is specified for a first electronic currency and an issuance request to issue the first electronic currency, or a second input including designation to add an amount which is specified for a second electronic currency to possession amount information;
outputting, when receiving the first input, a first screen which requests input of second information to determine a condition about whether to permit a grant of a first premium of the first electronic currency, based on whether the first information corresponds to a first user who makes the issuance request or a second user different from the first user; and
outputting, when receiving the second input, a second screen which requests input of third information to determine a condition about whether to permit a grant of a second premium of the second electronic currency to a terminal which is used by a third user in a case where the third user who designates an addition of the amount is different from a fourth user who requests issuance of the second electronic currency.

10. The premium giving method according to claim 9, wherein the first screen is output when the first information corresponds to the first user.

11. The premium giving method according to claim 9, further comprising:
receiving the input of the second information on the first screen; and
adding, when judging that the first user is eligible for the first premium based on the second information, a premium amount which is provided from an account which manages money for the grant of the first premium, together with the amount of the first electronic currency, to a possession amount which is stored in association with the first user.

12. The premium giving method according to claim 9, further comprising:
receiving the input of the third information on the second screen; and
adding, when judging that the third user is eligible for the second premium based on the third information, a premium amount which is provided from an account which manages money used for the grant of the second premium, together with the amount of the second electronic currency, to a possession amount which is stored in association with the third user.
